(19) United States
(12) Patent Application Publication
(10) Pub. No.: US 2016/0284035 A1
(43) Pub. Date: Sep. 29, 2016

(54) CROWD-SOURCED ANALYSIS OF END USER LICENSE AGREEMENTS

(71) Applicant: Igor Muttik, Berkhamsted (GB)

(72) Inventor: Igor Muttik, Berkhamsted (GB)

(21) Appl. No.: 14/670,679

(22) Filed: Mar. 27, 2015

(51) Int. Cl. G06Q 50/18; G06F 17/27; G06F 17/30; G06Q 30/00

(52) U.S. Cl. CPC G06Q 50/18; G06Q 30/0185; G06F 17/2705; G06F 17/30522

(57) ABSTRACT

In an example, a computing device is provided with an analysis engine for helping a user to evaluate and make informed decisions about legal agreements such as an end-user license agreement (EULA). The EULA may be long and include provisions that are difficult for the user to understand. The analysis engine may capture the EULA and upload it to an analysis server, including a reputation database with stored “crowd-sourced” actions of other users who have encountered the same or similar EULAs. As an alternative to a centralized server, peer-to-peer crowd sourcing may also be used to derive a reputation. After receiving reputation data, the analysis engine may provide feedback to the user, who can then make an informed decision about whether to accept the EULA.

### FIELD OF THE DISCLOSURE

This application relates to the field of computing services, and more particularly to a system and method for providing crowd-sourced analysis of end-user license agreements.

### BACKGROUND

End-user license agreements (EULAs) are agreements that are commonly prepended to software distributed by software vendors such as independent software vendors (ISVs). In a normal use case, an ISV may distribute or make software available to a large number of end users. Before the end users are permitted to install or use the software, they are required to agree to the EULA.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIGS. 1A and 1B are network-level diagrams of user networks according to one or more examples of the present Specification.

FIG. 2 is a block diagram of a client device according to one or more examples of the present Specification.

FIG. 3 is a block diagram of a server device according to one or more examples of the present Specification.

FIG. 4 is a flow chart of a method performed by an analysis client according to one or more examples of the present Specification.

FIG. 5 is a flow chart of a method performed by an analysis client according to one or more examples of the present Specification.

FIG. 6 is a flow chart of a method performed by an analysis server engine according to one or more examples of the present Specification.

### DETAILED DESCRIPTION OF THE EMBODIMENTS

### Overview

In an example, a computing device is provided with an analysis engine for helping a user to evaluate and make informed decisions about legal agreements, such as an end-user license agreement (EULA). The EULA may be long and include provisions that are difficult for the user to understand. The analysis engine may capture the EULA and upload it to an analysis server, including a reputation database with stored “crowd-sourced” actions of other users who have encountered the same or similar EULAs. As an alternative to a centralized server, peer-to-peer crowd sourcing may also be used to derive a reputation. After receiving reputation data, the analysis engine may provide feedback to the user, who can then make an informed decision about whether to accept the EULA.

### EXAMPLE EMBODIMENTS OF THE DISCLOSURE

EULAs are a substantial and meaningful issue to many software end-users. In this context, an “end-user” may include one or more of an individual, a group, an enterprise, whether for profit or not, a family, any other collection of one or more individual users, or even another computing device that is configured to consume the software. The terms of a EULA can meaningfully affect the user's rights concerning not only what the user can do with the software itself, but also effecting external rights. For example, some EULAs include a clause that the user may not derogate or otherwise harm the reputation of the software or the ISV. In one extreme example, on Apr. 1, 2010, a gaming company added a clause to its EULA indicating that the user irrevocably gave his or her soul to the ISV. Reportedly, thousands of users agreed to this term before it was noticed.

In the last example, the timing of the change to the EULA is persuasive that term was intended as a joke, and in any case, it is not clear how courts could enforce the collection of souls. In the case of a priori limitations on the user's speech, such as prohibitions against criticizing the software, there are also valid questions whether those terms are legal, valid, and enforceable.

However, as a general rule, it is preferable for users not to enter into egregious contracts, rather than to rely on courts to invalidate or refuse to enforce draconian provisions of EULAs.

Another issue is that users often do not have an opportunity to view a EULA until after they have purchased the software, unwrapped it, and have started installing it. By this time, most retailers will not refund or exchange the purchase. Thus, the users only resource if he chooses not to accept the EULA is to contact the ISV and try to negotiate a refund in that way.

All of these issues are persuasive that it is in the user's best interest to carefully read and analyze each and every EULA for each and every piece of software that the user uses. However, as a practical matter, this is so improbable as to border on the impossible. For example, the current EULA for the popular iTunes software package is more than 50 pages long. Nor are these 50 pages friendly, accessible text that can be easily understood by the common man. Rather, these 50 pages are dense legalese that the average software end-user has no hope of reading, much less understanding, analyzing, and making informed decisions about. Thus, the best recourse for a truly conscientious user is to retain an attorney to read, analyze, and give a legal opinion on every single EULA that the user encounters. The difficulties with this proposition are so extreme that for most users, it would be preferable to return to graph paper and handwritten ledgers.

Thus, the inventors of the present application have recognized that it is desirable to have a software-based solution for assisting users in analyzing, understanding, and making informed decisions about software EULAs before accepting them. Advantageously, a software-based solution can take advantage of so-called “crowdsourcing” methodologies to aggregate inputs and analysis from a large number of users.

In one example, an end-user operates a common computing device, such as an ordinary laptop computer, tablet, desktop computer, or smart phone. The user installs on the computing device an analysis agent, which in one example runs as a background process. The analysis agent includes one or more logic elements comprising an analysis engine. While running in the background, the analysis agent may recognize when the user encounters a situation, such as a request to accept or reject a EULA. Alternatively, on-demand the user can explicitly invoke the analysis agents to analyze a EULA.

Upon recognizing a EULA or receiving an express request from the user, the analysis agent provides the content of the EULA to the analysis engine. In general terms, a purpose of the analysis engine is to receive the content of the EULA, receive external data about the EULA, and then to provide the user with a net analysis or advice to help the user make an informed decision about whether to accept or reject the EULA.

Advantageously, the user is thus able to make an informed decision, particularly regarding the effect of the EULA on his rights as a user. Further advantageously, in some contexts, the user can make informed decisions before spending money on the software. For example, if the end-user is considering purchasing the software, and is investigating the software online before purchasing, the user may provide information about the software to the analysis agent, and expressly request an analysis of the EULA. This may be possible even if the user does not have access to the EULA itself. For example, the analysis agents may communicate with an analysis server including a reputation repository database containing information about a large number of EULAs. Thus, even without access to the text of the EULA, the user may be able to gain crowd-sourced data about what other users thought of the EULA, and whether they accepted or rejected it.

Similarly, if the end user is browsing software in a brick and mortar store, the user might use a smart phone to retrieve information about the EULA of a software package the user is interested in purchasing. In this case, the user might use a camera of a smart phone to scan a UPC or QR code related to a particular piece of software. The analysis agents may pass this information to the analysis engine, which may query and analysis server to receive reputation information about the software.

Once the user makes a decision about the software based on the EULA, such as deciding whether to accept or reject the EULA, or deciding to buy or not buy the software, the user's choice may be uploaded to the analysis server as a further contribution to the reputation data for that software and its EULA.

EULA reputations need not be managed by a centralized analysis server. Rather, this is only one embodiment. In another embodiment, the analysis server may instead be distributed in a peer-to-peer (P2P) fashion.

The user may belong to a network such as a social network, or may designate one or more individuals whose input should be considered for each EULA. Each of those P2P users may also have an analysis agent running on his or her computing device. In that case, receiving external data about the EULA may not include receiving a global reputation for the EULA. Rather, the analysis engine may receive raw data from analysis agents running on user devices, and may construct therefrom a reputation for the software and its EULA. The analysis engine may then provide advice for the user. In this example, results may be further refined by designating certain users as more (or less) trusted than other users. For example, a user may value more highly the advice of a close friend than of a mere acquaintance. Or the user may provide particular weight to the advice or opinion of a peer user he knows to be an intellectual property attorney. Conversely, some users may be known or believed to “poison the well.” For example a user who automatically agrees to every EULA without reading or considering it, may be considered less valuable. Similarly, some users may provide deliberately skewed feedback, as part of a personal agenda, for financial gain, or some other reason. Input from such users may not be useful to an end user who does not share that particular agenda. Thus, when aggregating inputs from a plurality of sources, the analysis engine may apply weighting factors to certain inputs and it may even reject some inputs altogether.

Advantageously, even in cases where a centralized analysis server with a centralized reputation repository is used, the user may still be able to provide weighting factors. For example, the end user may know that strict adherents of the Free Software Foundation (FSF) are opposed to EULAs as a matter of principle. Thus, the strict adherents can be expected to uniformly reject all such EULAs. A rejection by a strict adherent of the FSF may thus provide little or no useful information to an end user who is not himself and adherent to free software principles. Similarly, rejection of a EULA for Microsoft Internet Explorer™ by a group of users known to be Firefox™ partisans may be deemed unhelpful. On the other hand, it may be desirable to give special credence to a group of users known to be IP attorneys, or users who are heavily invested in using the software package. A centralized analysis server may also provide a global EULA reputation as a baseline, and then provide adjustments to the baseline based on input from users known to be in the end-users social networks.

Results can be further improved by incorporating user context into analysis results. Context may be captured, for example, via live telemetry to a central server for redistribution, or to other agents via P2P communications. Context may include, by way of non-limiting example, the identity of the sending agent, and demographic data about the user, such as locales, time zone, location, operating system, installed software, and demographic data that the user may voluntarily provide, such as age, race, ethnicity, sex, interests, affiliations, memberships, and any other suitable contextual data. These contextual data may be used to provide more relevant results to the user.

For example, if the EULA includes a “forum selection clause” indicating that any lawsuit arising from the EULA will be heard by a court of competent jurisdiction within Orange County California, and will be governed by California law, the term may be wholly acceptable to an end-user residing in Orange County California. On the other hand, the term may be of greater concern to a user residing in Boston, Mass.

Further advantages can be realized by using fuzzy hashes to identify EULAs that are similar to but not necessarily identical to the EULA under consideration. This is particularly useful because many lawyers are fond of using legal forms and of reusing useful portions of existing agreements. Thus, a first ISV may adapt a EULA provided by a second ISV for use in its own software. Or an attorney retained by the first ISV may use a form agreement from the same form, but that an attorney for the second ISV used. In this case, the agreements may not be identical, but may have sufficient similarity that actions taken with respect to the 1st EULA are useful can usefully inform actions for the second EULA.

Furthermore, the entire EULA need not be substantially similar to the entire 2nd EULA for useful comparisons to be made. For example, an attorney for a first ISV may draft portions of a EULA that are not applicable to a second software provided by a second ISV. But that attorney may turn to a formbook to provide some of the more pedestrian sections of the EULA that do not need as much customization. An attorney for the 2nd ISV may use the same formbook to draft similar sections for the EULA of the 2nd software. Thus, although the second software packages may have little in common functionally, and may have portions of their respective EULAs that are vastly different, they may also share portions that are substantially similar. In that case, a piecewise fuzzy hash of the EULA may be performed to provide a fuzzy hash of individual sections and subsections. This may allow the analysis engine to locate similar sections in other EULAs, and provide information about those sections.

In some cases, users may go beyond simply accepting or rejecting a EULA. A well-informed user, such as a knowledgeable end-user, or an attorney specifically hired by a service provider to provide analysis and commentary on EULAs may provide rich information about portions of select EULAs. This commentary may initially focus on areas of high interest or sub-sections that are commonly used across multiple EULAs. For example, an attorney may provide insight into whether certain portions of a EULA have been found to be void, voidable, or otherwise unenforceable. Knowledgeable technical users may provide commentary on “gotchas” that arise from terms of EULAs that are of interest to them. In an enterprise, a single legal source (attorney) maybe dedicated to providing advice to multiple employees about the EULAs for commonly used software and software updates. The agent may also be automatically configured to accept EULAs by attorneys or software administrators.

When an end-user receives reputation advice on a EULA that he encounters, the advice may include commentary from those informed users. This may help to draw the user's attention to sections that are of particular concern, or conversely may point out sections and that are unlikely to be enforceable, even though they appear on the face to be extremely draconian.

Ultimately, an analysis agent of the present Specification may enable ordinary users to make meaningful and informed decisions about which software to install and which EULAs to accept. Additional benefits are realized as the scope of the user base increases, and ISVs begin to realize that the EULA itself is becoming a differentiating factor for canny consumers. This may help to strike a balance wherein EULAs are drafted to sufficiently protect the ISV, without being overreaching or unnecessarily draconian.

A system and method for crowdsourcing license agreements will now be described with more particular reference to the appended FIGURES. Throughout the FIGURES, common numerals are used to specify common elements across multiple FIGURES. However, this is not intended to imply a necessary or strict relationship between different embodiments disclosed herein. In some cases, one or more different examples or species of the same elements may be referred to in a hyphenated form. Thus, for example, the numerals 1xx-1 and 1xx-2 may refer to two different species or examples of a class of objects referred to as 1xx.

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Different embodiments many have different advantages, and no particular advantage is necessarily required of any embodiment.

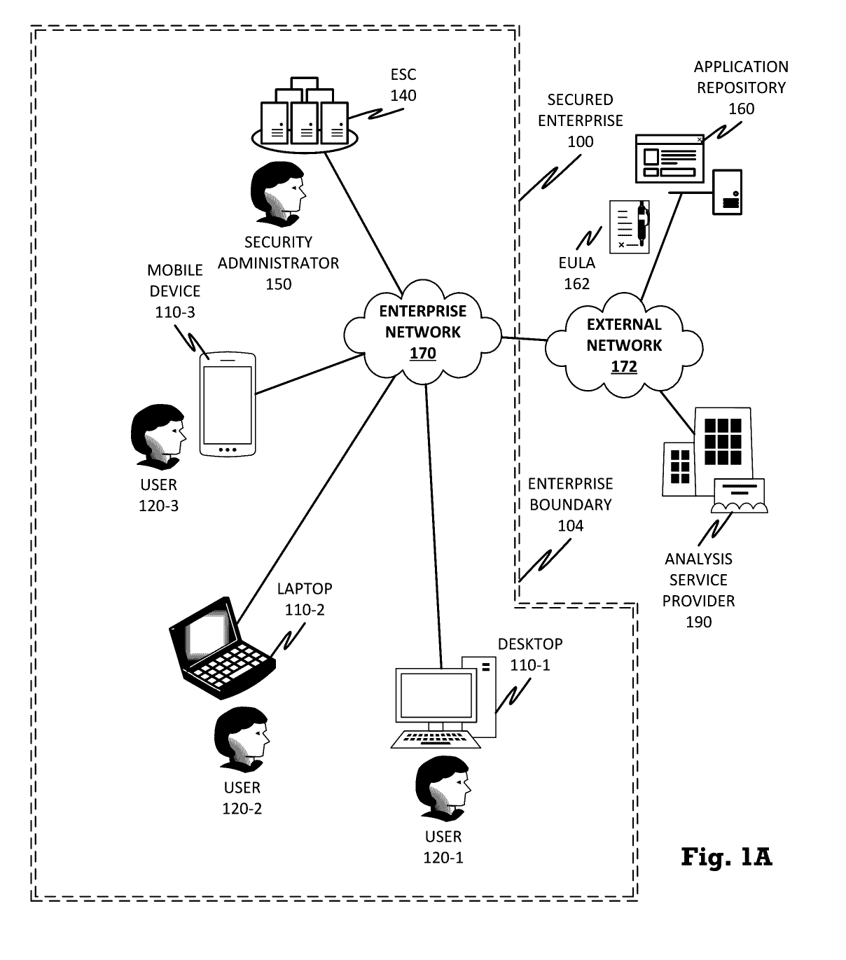

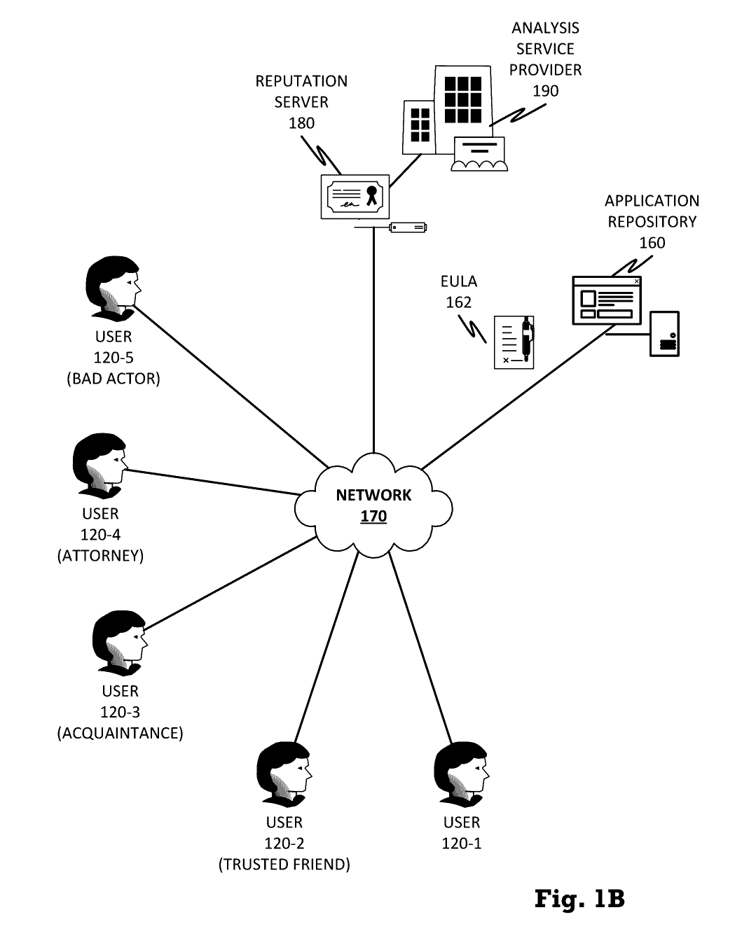

FIG. 1A is a network-level diagram of a secured enterprise 100 according to one or more examples of the present Specification. In the example of FIG. 1A, a plurality of users 120 operates a plurality of client devices 110. Specifically, user 120-1 operates desktop computer 110-1. User 120-2 operates laptop computer 110-2. And user 120-3 operates mobile device 110-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 110-1, which in one embodiment may be an engineering workstation, may be more likely to use one of Microsoft Windows, Linux, Unix, or Mac OSX. Laptop computer 110-2, which is usually a portable off-the-shelf device with fewer customization options, may be more likely to run Microsoft Windows or Mac OSX. Mobile device 110-3 may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of non-limiting example. Enterprise network 170 may also include one or more servers, firewalls, routers, switches, security appliances, antivirus servers, or other useful network devices. In this illustration, enterprise network 170 is shown as a single network for simplicity, but in some embodiments, enterprise network 170 may include a large number of networks, such as one or more enterprise intranets connected to the Internet. Enterprise network 170 may also provide access to an external network, such as the Internet, via external network 172. External network 172 may similarly be any suitable type of network.

One or more computing devices configured as an enterprise security controller (ESC) 140 may also operate on enterprise network 170. ESC 140 may provide a user interface for a security administrator 150 to define enterprise security policies, which ESC 140 may enforce on enterprise network 170 and across client devices 120.

Secured enterprise 100 may encounter a variety of “security objects” on the network. A security object may be any object that operates on or interacts with enterprise network 170 and that has actual or potential security implications. In one example, an object may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Enterprise security policies may include authentication policies, network usage policies, network resource quotas, antivirus policies, and restrictions on executable objects on client devices 110 by way of non-limiting example. Various network servers may provide substantive services such as routing, networking, enterprise data services, and enterprise applications.

Secure enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172.

It may be a goal of users 120 and secure enterprise 100 to successfully operate client devices 110 without interference from attackers or from unwanted security objects.

Application repository 160 may represent a Windows or Apple “App Store” or update service, a Unix-like repository or ports collection, or other network service providing users 120 the ability to interactively or automatically download and install applications (or other executable objects) on client devices 110.

In some cases, secured enterprise 100 may provide policies concerning the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 120.

It should be noted that retrieval of applications from application repository 160 is provided by way of non-limiting example, and there are many other contexts in which the need for a user 120 to make an informed decision about accepting or rejecting an agreement can arise. For example, instead of accessing software on application repository 160, a user 120 may access a website, including a terms of use and/or a privacy policy. Users may also install software from readable media such as CDs or DVDs.

When an ISV provides an application via application repository 160, it may attach thereto a EULA 162, and accepting EULA 162 may be a precondition to installing the software. However, EULA 162 may raise security and confidentiality concerns, particularly in for-profit enterprises. For example, EULA 162 may require the user to agree to inspection of premises and records, which can be inimical to confidentiality requirements. In other examples, “grayware” applications may perform covert data collection, such as collecting contacts and private data, purportedly shielded by a EULA in which the end user agrees to such collections. Such software may be classified as “spyware” (collecting information) or “adware” (displaying obtrusive and unwanted advertisements). If enterprise 100 is a large commercial enterprise, it may be a simple matter to simply submit all EULAs to a legal department for formal analysis. But if enterprise 100 is, for example, a small nonprofit or even a family or informal network of friends, legal compliance may be much more difficult and complicated.

Secured enterprise 100 may also contract with or subscribe to a security services provider, which may provide security services, updates, antivirus definitions, patches, products, and services. McAfee®, Inc. is a non-limiting example of such a security services provider that offers comprehensive security and antivirus solutions. In some cases, security services providers may include a threat intelligence capability such as the global threat intelligence (GTI™) database provided by McAfee Inc. The security services provider may update its threat intelligence database by analyzing new candidate malicious objects as they appear on client networks and characterizing them as malicious or benign.

In an example, the security services provider may also act as an analysis service provider 190. Advantageously, agreement analytics may be provided as a value-added supplement to traditional security services. Because legal obligations can be intertwined with security, as described herein, a security services provider may be a natural fit for providing integrated agreement analytics. However, this is provided by way of non-limiting example only, and in other examples, analysis service provider 190 can provide a standalone service, or agreement analytics may be provided as an a la carte option from another service provider.

Analysis service provider 190 may provide services including a centralized reputation database for agreements, and in some cases may also provide professional analysis and commentary of EULAs submitted by users.

In some embodiments, secured enterprise 100 may simply be a family, with parents assuming the role of security administrator 150. The parents may wish to protect their children from undesirable content, such as illegal software, pornography, adware, spyware, age-inappropriate content and advocacy for certain political, religious, or social movements, or forums for discussing illegal or dangerous activities, by way of non-limiting example. In this case, the parent may perform some or all of the duties of security administrator 150.

Secured enterprise 100 may also be a social network, club, or other informal group. In that context, secured enterprise 100 need not even be an organized enterprise. Rather, secured enterprise 100 may represent a mapping of social network connections between, for example, user 120-1 and other users 120.

FIG. 1B provides a simplified network view, in which it is seen that user 120-1 has a number of connections to other users 120. These connections may not be formally defined, and users 120 may simply include friends, acquaintances, business associates, or other people with whom user 120-1 shares a connection.

As before, an ISV provides software to application repository 160, and users 120 receive the application from application repository 160, including an attached EULA 162. Analysis service provider 190 provides a reputation server 180, which includes an analysis server engine configured to provide centralized license agreement analysis services. This should also be understood as a non-limiting example. In other examples, users 120 may connect to one another in a P2P fashion without the need for an intermediary reputation server 180.

In an example, user 120-1 encounters EULA 162, and must make an informed decision about whether to accept or reject EULA 162. User 120-1 may expressly invoke an analysis agent on his computing device, or an analysis agent running as a background process may detect that a EULA 162 has been displayed with a request for user 120-1 to accept the EULA.

The analysis agent then queries external data sources, such as in a centralized or in a peer-to-peer fashion, and receives external data. In this example, each one of users 120-2, 120-3, 120-4, and 120-5 may have encountered EULA 162.

By way of example, user 120-2 may be a trusted friend. Thus, user 120-1 may trust the judgment of user 120-2, regardless of whether user 120-2 has a particular skill set or special knowledge concerning EULA 162. Thus, when assigning a reputation to EULA 162, the analysis engine may give input from user 120-2 additional weight. This may represent, for example, that user 120-1 and user 120-2 have a shared set of values or principles, so that thoughtful decisions made by one may reasonably inform decisions of the other.

In other examples, user 120-2 may be a respected or trusted expert in an area of interest to user 120-1. For example, user 120-1 and user 120-2 may both be interested in photography, and thus may have shared concerns about EULAs or website terms of use that claim a copyright or license in works that are used or uploaded. (For example, users have at times expressed concern over Facebook's policies concerning use of art and photographs uploaded.) Because of the shared interest and shared concern, user 120-2's actions with respect to EULA 162 may be afforded greater weight.

User 120-3, on the other hand, is merely an acquaintance of user 120-1. For example, user 120-1 may have met user 120-3 only a handful of times at professional functions, and they may have connected to one another on a social networking site such as LinkedIn. Thus, user 120-1 has little information about user 120-3, including his level of technical expertise and whether they have any shared values or principles. While actions taken by user 120-3 with respect to EULA 162 are still useful in informing user 120-1, they may be afforded a reduced weight.

User 120-4 in this example is an attorney. User 120-1 may trust that user 120-4 is informed about legal issues, and thus assume that user 120-4 will make informed and logical decisions about EULA 162. Thus, even though user 120-1 and user 120-4 may not be personally close, user 120-1 trusts the judgment of user 120-4 with respect to EULA 162 because of particularized knowledge. Input from user 120-4 may therefore be afforded greater weight, even though user 120-4 is not providing specific legal advice or opinions. It may be beneficial to establish the authenticity of such input, for example based on public key infrastructure (PKI) providing trusted certificate to create a digital signature of the individual's crowd sourced input. Such signed inputs are harder to forge and may carry greater weight and trust value. Other, less secure, forms of identifying the users and distinguishing them from computers, for example, biometrics and CAPTCHA may also be employed.

User 120-5 may be deemed a “bad actor.” This does not necessarily imply that user 120-5 is a criminal or hacker, but simply means that from the perspective of user 120-1, input from user 120-5 may be reasonably considered irrelevant, or even counterproductive. For example, if user 120-1 is a Firefox partisan, and user 120-5 is an Internet Explorer partisan, the two users may share a mutual distrust of one another's decisions about browser EULAs.

On the other hand, even when user 120-5 does not act illegally, he may act to deliberately taint results. For example, if user 120-5 is a strident ideologue of the “Free Software” movement, and also lacking in ethics, he may deliberately try to undermine EULAs because he believes that EULAs are per se anathema to his cause. In that case, the analysis engine provides more relevant results to user 120-1, who is not a Free Software crusader, by excluding input from user 120-5.

Weighting may also be influenced by heuristic algorithms, such as those based on scrolling patterns. For example, even though user 120-4 is an attorney and presumed to be knowledgeable about license agreements, if he immediately scrolls to the bottom of the EULA and clicks “Accept,” it is unlikely that he actually read or thought about the text. Thus, his particular skills do not come into play because they were (apparently) not employed. In that case, extra weighting given to user 120-4 may be nullified, and in some cases, user 120-4 may even be given a below-unity weighting factor.

Finally, analysis service provider 190 may itself employee attorneys, agents, engineers, or other experts specifically to analyze common EULAs, or commonly encountered provisions in EULAs. When providing a reputation for EULA 162, analysis service provider 190 may thus include rich or in-depth commentary or analysis of EULA 162.

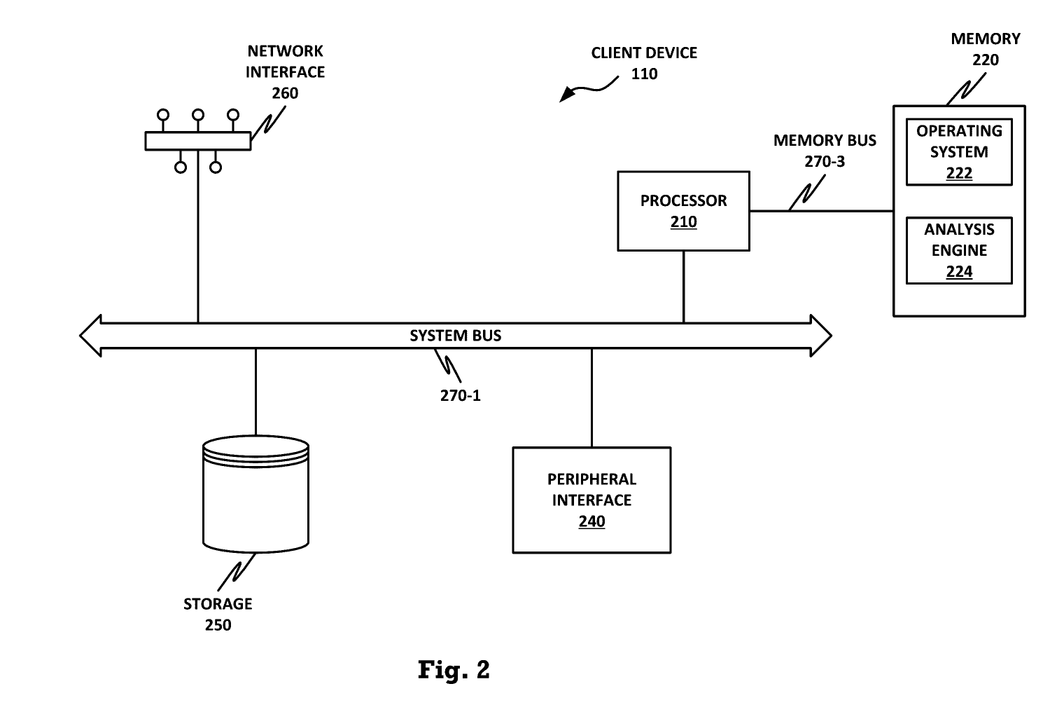

FIG. 2 is a block diagram of client device 110 according to one or more examples of the present Specification. Client device 110 may be any suitable computing device. In various embodiments, a “computing device” may be or comprise, by way of non-limiting example, a computer, virtual machine, workstation, server, mainframe, embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or micro-electromechanical device for processing and communicating data.

Client device 110 includes a processor 210 connected to a memory 220, having stored therein executable instructions for providing an operating system 222 and at least software portions of an analysis engine 224. Other components of client device 110 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this Specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this Specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this Specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of analysis engine 224. Many other configurations are also possible, and are intended to be encompassed within the broad scope of this Specification.

Network interface 260 may be provided to communicatively couple client device 110 to a wired or wireless network. A “network,” as used throughout this Specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Analysis engine 224, in one example, is operable to carry out computer-implemented methods as described in this Specification. Analysis engine 224 may include one or more non-transitory computer-readable mediums having stored thereon executable instructions operable to instruct a processor to provide an analysis engine. As used throughout this Specification, an “engine” includes any combination of one or more logic elements, of similar or dissimilar species, operable for and configured to perform one or more methods provided by analysis engine 224. Thus, analysis engine 224 may comprise one or more logic elements configured to provide methods as disclosed in this Specification. In some cases, analysis engine 224 may include a special integrated circuit designed to carry out a method or a part thereof, and may also include software instructions operable to instruct a processor to perform the method. In some cases, analysis engine 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, boot up procedure, BIOS subroutine, or any similar program that operates without direct user interaction. In certain embodiments, daemon processes may run with elevated privileges in a “driver space,” or in ring 0, 1, or 2 in a protection ring architecture, or it may also operate in a trusted execution environment (TEE) such as, for example, Intel® software guard extensions (SGX). It should also be noted that analysis engine 224 may also include other hardware and software, including configuration files, registry entries, and interactive or user-mode software by way of non-limiting example.

In one example, analysis engine 224 includes executable instructions stored on a non-transitory medium operable to perform a method according to this Specification. At an appropriate time, such as upon booting client device 110 or upon a command from operating system 222 or a user 120, processor 210 may retrieve a copy of analysis engine 224 (or software portions thereof) from storage 250 and load it into memory 220. Processor 210 may then iteratively execute the instructions of analysis engine 224 to provide the desired method. If a portion of analysis engine 224 is to run as a daemon or monitor process, it may be referred to as an “analysis agent.” However, no attempt is made herein to draw a bright line between the “agent” portion and the “engine” portion, and in a more general sense, the agent can be thought of as a subset of the engine, specifically the portion that monitors for events of interest.

Peripheral interface 240 may be configured to interface with any auxiliary device that connects to client device 110 but that is not necessarily a part of the core architecture of client device 110. A peripheral may be operable to provide extended functionality to client device 110, and may or may not be wholly dependent on client device 110. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example.

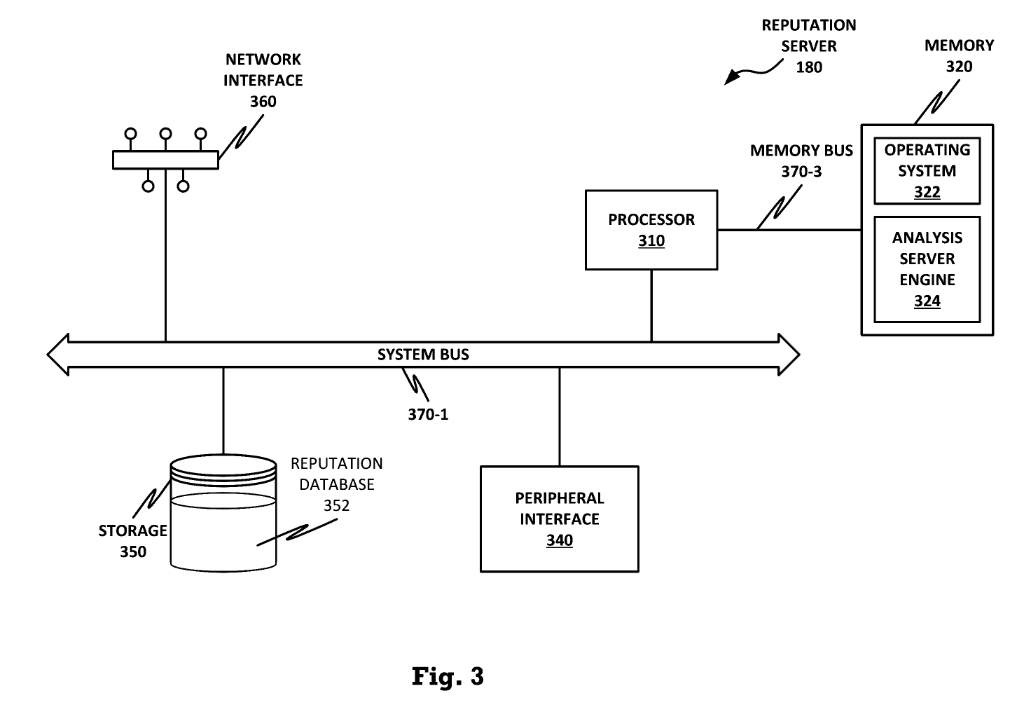

FIG. 3 is a block diagram of reputation server 180 according to one or more examples of the present Specification. Reputation server 180 may be any suitable computing device, as described in connection with FIG. 2. In general, the definitions and examples of FIG. 2 may be considered as equally applicable to FIG. 3, unless specifically stated otherwise. Reputation server 180 is described herein separately to illustrate that in certain embodiments, logical operations according to this Specification may be divided along a client-server model, wherein client device 110 provides certain localized tasks, while reputation server 180 provides certain other centralized tasks.

Reputation server 180 includes a processor 310 connected to a memory 320, having stored therein executable instructions for providing an operating system 322 and at least software portions of an analysis server engine 324. Other components of reputation server 180 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of analysis server engine 324.

Storage 350 includes a reputation database 352. It should be noted particularly that storage 350 need not be a local storage or hard disk of reputation server 180. Indeed, in many embodiments, reputation server 180 may in fact be provided as a virtual machine spawned by a hypervisor, with no local physically attached permanent storage. Rather, the virtual machine may access a file server, which provides access to a remote hard disk array. It should also be understood that reputation database 352 may in many cases be provided by a separate database server. Thus, it should be understood that the functions disclosed in this illustration are provided by way of illustration only, and are not intended to require or dictate a particular hardware and/or software configuration.

Network interface 360 may be provided to communicatively couple reputation server 180 to a wired or wireless network, and may include one or more logic elements as described in FIG. 2.

Analysis server engine 324 is an engine as described in FIG. 2 and, in one example, includes one or more logic elements operable to carry out computer-implemented methods as described in this Specification. Software portions of analysis server engine 324 may run as a daemon process.

Analysis server engine 324 may include one or more non-transitory computer-readable mediums having stored thereon executable instructions operable to instruct a processor to provide an analysis engine. At an appropriate time, such as upon booting reputation server 180 or upon a command from operating system 322 or a user 120 or security administrator 150, processor 310 may retrieve a copy of analysis server engine 324 (or software portions thereof) from storage 350 and load it into memory 320. Processor 310 may then iteratively execute the instructions of analysis server engine 324 to provide the desired method.

Peripheral interface 340 may be configured to interface with any auxiliary device that connects to reputation server 180 but that is not necessarily a part of the core architecture of reputation server 180. A peripheral may be operable to provide extended functionality to reputation server 180, and may or may not be wholly dependent on reputation server 180. Peripherals may include, by way of non-limiting examples, any of the peripherals disclosed in FIG. 2.

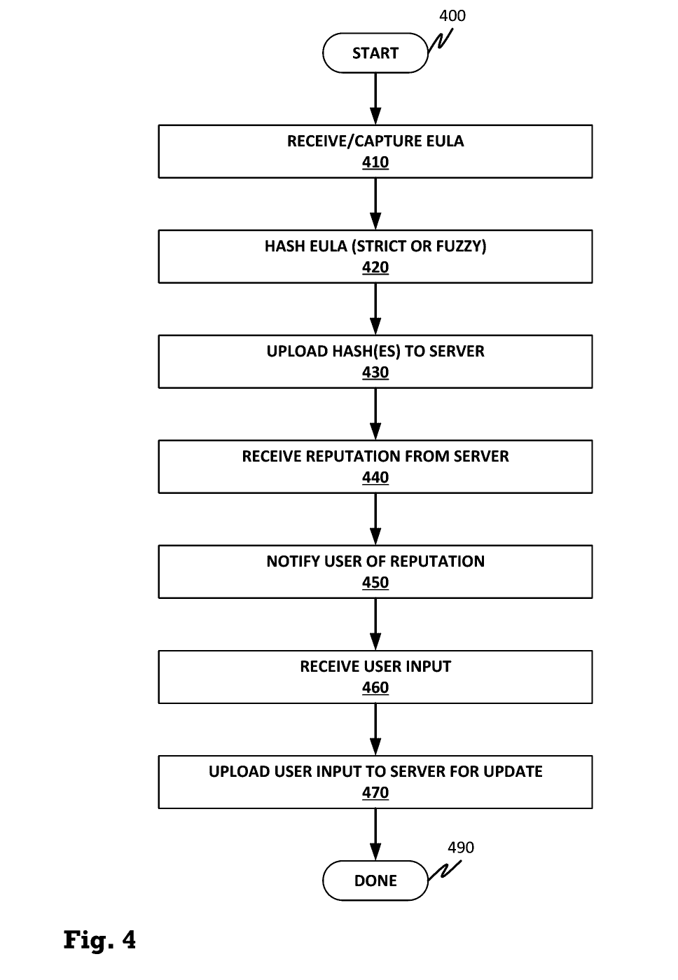

FIG. 4 is a flowchart of a method 400 performed by an analysis engine 224 of computing device 110 according to one or more examples of the present Specification.

In block 410, analysis engine 224 receives or captures EULA 162. This may include, for example, receiving a URL of a website containing the EULA, detecting the EULA in a text box spawned by an install process, performing a screen scrape, or receiving the content of a EULA directly from a user, along with an express indication of analysis engine 224 and a request for analysis.

In block 420, analysis engine 224 may perform a hash of EULA 162. This enables analysis engine 224 to communicate with reputation server 180 while consuming less bandwidth. In some examples, if reputation server 180 does not recognize the hash as belonging to a EULA already in its reputation database, reputation server 180 may request the full text or contents of EULA 162 so that they can be stored in reputation database 352.

Instead of or in addition to a strict hash, analysis agent 224 may perform a fuzzy hash so that EULA 162 can be compared with similar EULAs that do not necessarily match. Advantageously, this can be used not only to compare EULAs between different ISVs, but also to detect changes in the EULA for a particular piece of software. When changes are detected, analysis engine 224 may display, along with advice and other information, a markup version of the license showing what changes have been made since the last version. This helps a user stay up-to-date on the latest versions of EULAs he has agreed to. This may happen, in particular, when updates to a program are downloaded and installed, and the user is required to once again accept a EULA before continuing to use the software. In that case, the user may be very interested in what changes have been made since a previous version of the EULA.

In block 430, analysis engine 224 uploads the hash to a server such as reputation server 180.

In block 440, analysis engine 224 receives reputation data from the server. As discussed above, this may include either or both of receiving reputation data from a centralized server, or receiving peer-to-peer data from devices 120. Also within block 440, depending on how much logic is provided on the end of analysis engine 224 versus analysis server agent 324 of FIG. 3, analysis engine 224 may perform additional processing to compute reputation information about the EULA.

In block 450, analysis engine 224 notifies user 120 of the computer reputation, and may also provide additional rich data, such as commentary or analysis. In one embodiment the reputation may be visualized by using red, amber and green colors in order to simplify understanding by the end user.

In block 460, analysis engine 224 receives input from user 120, potentially including one of accepting or rejecting EULA 162. In some cases, user 120 may also provide markup, analysis, and or commentary on EULA 162. In one embodiment the EULA may be accepted automatically by the agent.

In block 470, analysis engine 224 uploads user input to server 180 so that reputation database 352 can be updated.

In block 490, the method is done.

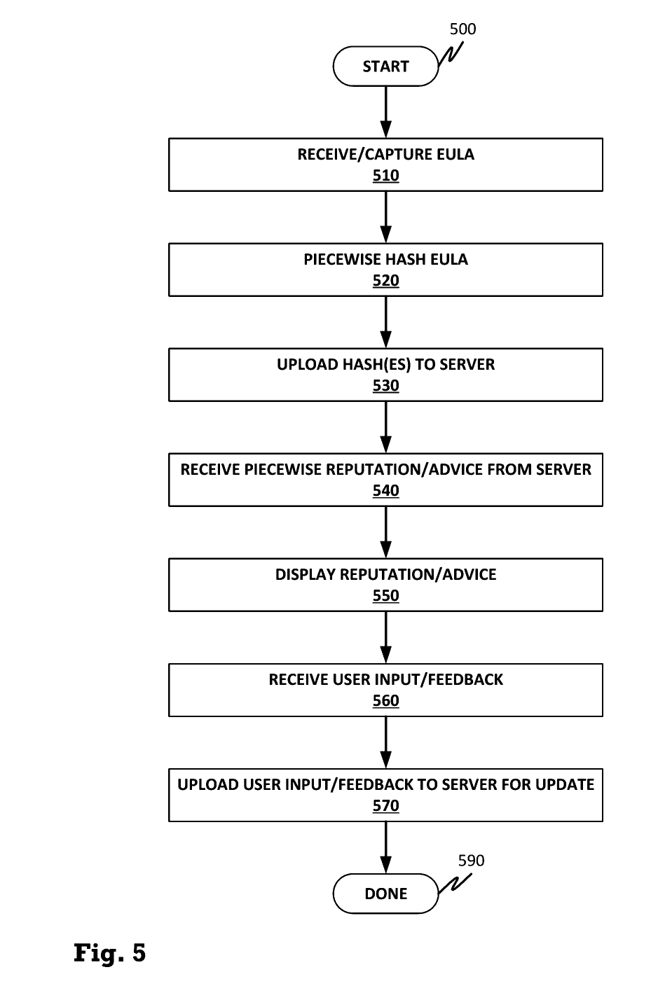

FIG. 5 is a block diagram of a method 500 alternatively or additionally provided by analysis engine 224 of client device 110.

In block 510, as before, analysis engine 224 receives or otherwise captures EULA 162.

In block 520, analysis engine 224 performs a piecewise hash of EULA 162. The piecewise hash provides a hash of individual sections so they can be compared to the hashes of other individual sections for finding common or similar terms with in license agreements.

In block 530, analysis engine 224 uploads one or more hashes to server 180 (as a non-limiting example such hashes may cover sections, paragraphs or sentences of the EULA). Note that block 530 could alternatively or additionally include communicating in a P2P fashion with other devices.

In block 540, analysis engine 224 receives piecewise reputation and or advice from server 180, or from peer devices 120.

As described above, this could include analysis on or commentary of particular sections, including legal analysis of the enforceability and viability of individual sections.

In block 550, analysis engine 224 displays reputation and advice information to be consumed by user 120.

In block 560, analysis engine 224 receives user input and or feedback from user 120. This may be provided via a user interface, application programming interface, or other intermediary. In one embodiment the EULA may be accepted automatically by the agent.

In block 570, analysis engine 224 may upload user input and or feedback to server 184. Alternatively, in a P2P embodiment, analysis agent 224 may store the action on a local data store, and provide the information remotely only when requested by a peer device.

In block 590, the method is done.

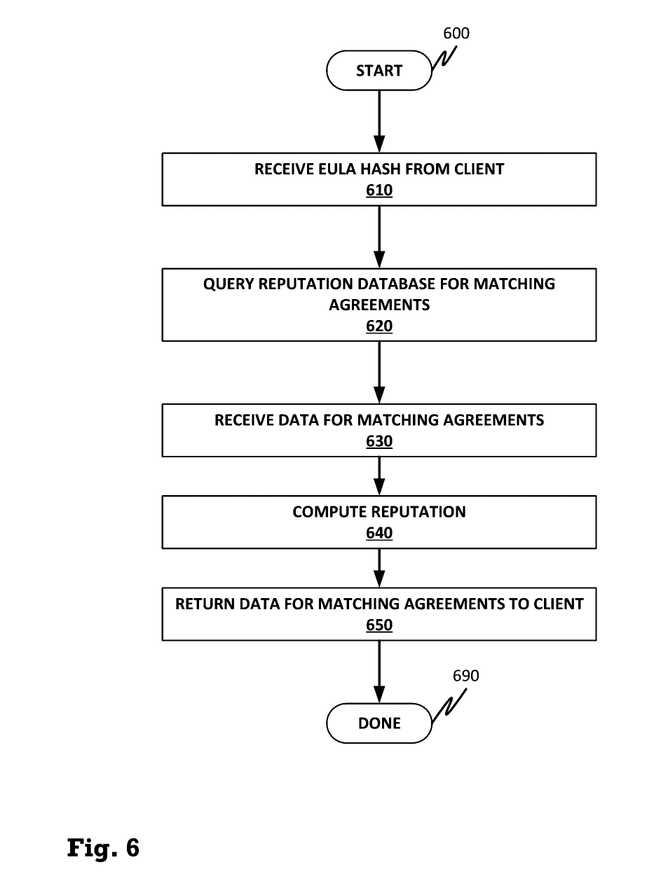

FIG. 6 is a flowchart of a method 600 performed by a server device, such as reputation server 180 of FIG. 1B.

In block 610, the reputation server receives a EULA hash from a client device running an analysis agent 224. This may be either or both of a full hash or a piecewise hash, and may include either or both of a strict hash or a fuzzy hash.

In block 620, analysis server engine 324 queries reputation database 352 for matching agreements, and or clauses in agreements.

In block 630, analysis server engine 324 receives from reputation database 352 data on matching agreements if they are available.

In block 640, analysis server engine 324 computes a derived reputation for the UI on endpoint device 110 specifically within the context of user 120. This may be done to the limit of available data, and or according to the goal considerations concerning storing user data. Note that in some embodiments, calculating of a reputation may be distributed to client devices instead, and may occur within analysis engine 224. It should also be noted that the reputation need not be a simple duplicate of a reputation retrieved from reputation database 352. Rather, additional and more advanced processing may be performed at this stage.

In block 650, analysis server engine 324 returns data for matching agreements to client device 110 for use by user 120.

In block 690, the method is done.

In an embodiment, to request external information about a EULA, an analysis engine may transmit either the entire EULA, or use hashing. To make hashing more useful, the analysis engine may normalize the EULA, such as by removing white space and capitalization.

In an embodiment, hashing can be either strict hashing or fuzzy hashing.

In an embodiment, a EULA can be split into sections, which can be hashed or fingerprinted (strictly or fuzzily), and the hashes can be piecewise transmitted and compared to match with prior EULAs that are the same or similar, or that have the same or similar sections.

In an embodiment, newly encountered EULAs can be evaluated to find portions that are identical to or similar to portions of existing EULAs.

In an embodiment, the similarity between two EULAs may be computed based on standard clustering algorithms, where the “distance” between a first EULA and a second EULA is determined by the number of changes required to convert one into the other. This may help in pointing end users to the “nearest match” EULA.

In an embodiment, commentary and analysis related to the “nearest match” EULA may be provided to a user to aid in analysis of a new EULA.

In an embodiment, the analysis agent may communicate comments, analysis, legal advice, and/or warnings to an end user looking at a EULA.

In an embodiment, the analysis engine may heuristically determine whether the user spent enough time looking at the EULA, and adjust a reliability score appropriately.

In an embodiment, a trusted third party, such as an attorney or other expert retained by an analysis service provider, may provide expert advice and analysis.

In an embodiment, an analysis service provider may provide or sell to ISVs statistical data about users' acceptance rates of their EULAs.

In an embodiment, rich content may be provided, including for example legal analysis of the enforceability of provisions of a EULA in a specific jurisdiction.

In an embodiment, advice to a user relative to a EULA may be sensitive to the user's context.

In an embodiment, crowd sourced inputs are cryptographically verified, or verified via user authentication (username/password combination, biometric authorization, two-factor authorization or similar), or verified via CAPTCHA or other method for verifying that an end user is human.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the Specification, to limit this disclosure in any way that is not otherwise reflected in the appended claims.

### EXAMPLE IMPLEMENTATIONS

There is disclosed in an example an apparatus comprising a network interface; and one or more logic elements comprising an analysis engine operable for: receiving text of an agreement-under-analysis; receiving at least one external input about the agreement-under-analysis; deriving a reputation for the agreement-under-analysis based at least in part on the at least one external input; and communicating advice to an end user concerning the agreement-under-analysis based at least in part on the reputation.

There is further disclosed an example, wherein the agreement-under-analysis is a software end user license agreement (EULA).

There is further disclosed an example, wherein receiving at least one external input comprises receiving an input from a social network connection of the end user.

There is further disclosed an example, wherein receiving at least one external input comprises capturing user context information.

There is further disclosed an example, wherein receiving at least one external input comprises assigning the at least one external input a weighting.

There is further disclosed an example, wherein computing a reputation for the agreement-under-analysis comprises applying exclusions to at least one data source.

There is further disclosed an example, wherein receiving at least one external input about the agreement-under-analysis comprises querying a reputation server.

There is further disclosed an example, wherein receiving at least one external input about the agreement-under-analysis comprises querying a peer apparatus.

There is further disclosed an example, wherein receiving at least one external input about the agreement-under-analysis comprises receiving a plurality of inputs corresponding to stages of a multiple-stage acceptance.

There is further disclosed an example, wherein receiving at least one external input about the agreement-under-analysis comprises receiving text of a portion of a second agreement, the portion of the second agreement being substantially identical to a portion of the agreement-under-consideration.

There is further disclosed an example, wherein communicating advice to the end user comprises providing analysis of the portion of the agreement-under-consideration.

There is further disclosed an example, wherein receiving at least one external input about the agreement-under-analysis comprises receiving text of a portion of a second agreement, the portion of the second agreement being substantially similar to a portion of the agreement-under-consideration.

There is further disclosed an example, wherein receiving at least one external input comprises cryptographically verifying the at least one external input.

There is further disclosed in an example, one or more computer-readable storage mediums having stored thereon executable operable for providing an analysis engine operable for: receiving text of an agreement-under-analysis; receiving at least one external input about the agreement-under-analysis; computing a reputation for the agreement-under-analysis; and communicating advice to an end user concerning the agreement-under-analysis based at least in part on the reputation.

There is further disclosed an example, wherein the agreement-under-analysis is a software end user license agreement (EULA).

There is further disclosed an example, wherein receiving at least one external input comprises receiving an input from a social network connection of the end user.

There is further disclosed an example, wherein receiving at least one external input comprises capturing user context information.

There is further disclosed an example, wherein receiving at least one external input comprises assigning the at least one external input a weighting.

There is further disclosed an example, wherein receiving at least one external input about the agreement-under-analysis comprises receiving a plurality of inputs corresponding to stages of a multiple-stage acceptance.

There is further disclosed an example, wherein receiving at least one external input about the agreement-under-analysis comprises receiving text of a portion of a second agreement, the portion of the second agreement being substantially identical to a portion of the agreement-under-consideration.

There is further disclosed an example, wherein communicating advice to the end user comprises providing analysis of the portion of the agreement-under-consideration.

There is further disclosed an example, wherein receiving at least one external input about the agreement-under-analysis comprises receiving text of a portion of a second agreement, the portion of the second agreement being substantially similar to a portion of the agreement-under-consideration.

There is further disclosed an example, wherein communicating advice to the end user comprises providing analysis of the portion of the agreement-under-consideration.

There is further disclosed in an example, an analysis server apparatus, comprising: one or more logical elements operable to provide an analysis server engine, operable for: receiving information about an agreement-under-analysis from a client engine; querying a reputation database for agreements that are a match for the agreement-under-analysis; computing a reputation score for the agreement-under-analysis; and sending the reputation score to the client engine.

There is further disclosed an example, wherein the agreement-under-analysis is an end-user license agreement.

There is further disclosed in an example, a method comprising performing the instructions disclosed in any of the examples.

There is further disclosed in an example, an apparatus comprising means for performing the method of any of the examples.

There is further disclosed an example, wherein the apparatus comprises a processor and memory.

There is further disclosed in an example, an apparatus further comprising a computer-readable medium having stored thereon software instructions for performing the method of any of the examples.

What is claimed is:

1. An apparatus comprising:
a network interface; and
one or more logic elements comprising an analysis engine operable for:
receiving text of an agreement-under-analysis;
receiving at least one external input about the agreement-under-analysis;
deriving a reputation for the agreement-under-analysis based at least in part on the at least one external input; and
communicating advice to an end user concerning the agreement-under-analysis based at least in part on the reputation.

2. The apparatus of claim 1, wherein the agreement-under-analysis is a software end user license agreement (EULA).

3. The apparatus of claim 1, wherein receiving at least one external input comprises receiving an input from a social network connection of the end user.

4. The apparatus of claim 1, wherein receiving at least one external input comprises capturing user context information.

5. The apparatus of claim 1, wherein receiving at least one external input comprises assigning the at least one external input a weighting.

6. The apparatus of claim 1, wherein computing a reputation for the agreement-under-analysis comprises applying exclusions to at least one data source.

7. The apparatus of claim 1, wherein receiving at least one external input about the agreement-under-analysis comprises querying a reputation server.

8. The apparatus of claim 1, wherein receiving at least one external input about the agreement-under-analysis comprises querying a peer apparatus.

9. The apparatus of claim 1, wherein receiving at least one external input about the agreement-under-analysis comprises receiving a plurality of inputs corresponding to stages of a multiple-stage acceptance.

10. The apparatus of claim 1, wherein receiving at least one external input about the agreement-under-analysis comprises receiving text of a portion of a second agreement, the portion of the second agreement being substantially identical to a portion of the agreement-under-consideration.

11. The apparatus of claim 10, wherein communicating advice to the end user comprises providing analysis of the portion of the agreement-under-consideration.

12. The apparatus of claim 1, wherein receiving at least one external input about the agreement-under-analysis comprises receiving text of a portion of a second agreement, the portion of the second agreement being substantially similar to a portion of the agreement-under-consideration.

13. The apparatus of claim 12, wherein receiving at least one external input comprises cryptographically verifying the at least one external input.

14. One or more computer-readable storage mediums having stored thereon executable operable for providing an analysis engine operable for:
receiving text of an agreement-under-analysis;
receiving at least one external input about the agreement-under-analysis;
computing a reputation for the agreement-under-analysis; and
communicating advice to an end user concerning the agreement-under-analysis based at least in part on the reputation.

15. The apparatus of claim 14, wherein the agreement-under-analysis is a software end user license agreement (EULA).

16. The apparatus of claim 14, wherein receiving at least one external input comprises receiving an input from a social network connection of the end user.

17. The apparatus of claim 14, wherein receiving at least one external input comprises capturing user context information.

18. The apparatus of claim 14, wherein receiving at least one external input comprises assigning the at least one external input a weighting.

19. The apparatus of claim 14, wherein receiving at least one external input about the agreement-under-analysis comprises receiving a plurality of inputs corresponding to stages of a multiple-stage acceptance.

20. The apparatus of claim 14, wherein receiving at least one external input about the agreement-under-analysis comprises receiving text of a portion of a second agreement, the portion of the second agreement being substantially identical to a portion of the agreement-under-consideration.

21. The apparatus of claim 20, wherein communicating advice to the end user comprises providing analysis of the portion of the agreement-under-consideration.

22. The apparatus of claim 14, wherein receiving at least one external input about the agreement-under-analysis comprises receiving text of a portion of a second agreement, the portion of the second agreement being substantially similar to a portion of the agreement-under-consideration.

23. The apparatus of claim 22, wherein communicating advice to the end user comprises providing analysis of the portion of the agreement-under-consideration.

24. An analysis server apparatus, comprising:
one or more logical elements operable to provide an analysis server engine, operable for:
receiving information about an agreement-under-analysis from a client engine;
querying a reputation database for agreements that are a match for the agreement-under-analysis;
computing a reputation score for the agreement-under-analysis; and
sending the reputation score to the client engine.

25. The analysis server apparatus of claim 24, wherein the agreement-under-analysis is an end-user license agreement.
